(19) United States
(12) Patent Application Publication
(10) Pub. No.: US 2010/0007406 A1
(43) Pub. Date: Jan. 14, 2010

(54) Electrical fuse devices and methods of operating the same

(75) Inventors: Junghun Sung, Yongin-si (KR); Choongrae Cho, Suwon-si (KR); Deokkee Kim, Seoul (KR); Soojung Hwang, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/453,533

(22) Filed: May 14, 2009

(30) Foreign Application Priority Data
Jul. 8, 2008 (KR) 10-2008-0066222

(51) Int. Cl. H01H 85/00

(52) U.S. Cl. 327/525

(57) ABSTRACT

Provided are an electrical fuse device and a method of operating the same. The electrical fuse device may include a fuse, and a driving element connected to the fuse and including a resistance change layer having a resistance that changes according to an applied voltage. The resistance change layer may have a metal-insulator transition (MIT) characteristic. As the driving element is turned on, a programming current may be applied to the fuse connected to the driving element.

This application claims priority under U.S.C. §119 to Korean Patent Application No. 10-2008-0066222, filed on Jul. 8, 2008, in the Korean Intellectual Property Office (KIPO), the entire contents of which are incorporated herein by reference.

### BACKGROUND

1. Technical Field

Example embodiments relate to an electrical device, and more particularly, to an electrical fuse device and a method of operating the same.

2. Description of the Related Art

A fuse device is used in semiconductor memory devices or logic devices for various purposes, e.g., repair of a defective cell, storing chip identification (ID), and circuit customization. For example, cells determined as being defective from among a relatively large number of cells in a memory device may be replaced with redundancy cells by using a fuse device. Accordingly, a decrease in manufacturing yield due to the defective cells may be prevented or reduced.

There are two types of fuse devices: a laser-blown type and an electrically-blown type. In the case of the laser-blown type fuse device, a laser beam is used to blow a fuse line. However, when irradiating a laser beam to a particular fuse line, fuse lines adjacent to the particular fuse line and/or other devices may be damaged.

On the other hand, in the case of the electrically-blown type of fuse device, a programming current is applied to a fuse link so that the fuse link is blown due to an electromigration (EM) effect and a Joule heating effect. The method of electrically blowing a fuse may be used after packaging of a semiconductor chip is completed, and a fuse device employing the method is referred to as an electrical fuse device.

Conventional electrical fuse devices include a driving transistor so as to apply a programming current to a fuse link. When the driving transistor is turned on, the programming current is applied to the fuse link connected to the driving transistor, thereby performing a programming operation. However, the size of the driving transistor must be increased to increase the intensity of the programming current so that a higher programming pre/post resistance ratio may be obtained in the conventional electrical fuse devices. Therefore, the conventional electrical fuse devices must use a driving transistor as large as possible, and thus, the size of the electrical fuse device is increased.

The area of the driving transistor in the conventional electrical fuse device is about 30% or more. In addition, although the size of the driving transistor is increased in the conventional electrical fuse device, obtaining a relatively large programming pre/post resistance ratio may be difficult. Furthermore, the resistance distribution after programming is comparatively large. Therefore, a reference resistor must be used so as to accurately perform a sensing operation. When the reference resistor is used, a sensing circuit having a complicated structure is needed. Thus, the size of the electrical fuse device is further increased, and constituting the electrical fuse device may be difficult.

### SUMMARY

Example embodiments provide an electrical fuse device having a driving element using resistance change in a resistance change layer. Example embodiments also provide a method of operating the electrical fuse device.

According to example embodiments, an electrical fuse device may include a fuse; and a driving element connected to the fuse and including a resistance change layer having a resistance that changes according to an applied voltage.

The resistance change layer may have a metal-insulator transition (MIT) characteristic. The driving element may include two electrodes and the resistance change layer between the two electrodes. The driving element may further include a gate which applies an electric field to the resistance change layer. The resistance change layer may include an oxide or a sulfide. The oxide may include at least one selected among from the group consisting of a vanadium (V) oxide, a niobium (Nb) oxide, and a titanium (Ti) oxide. The sulfide may include a vanadium (V) sulfide. The electrical fuse device may further include a single-ended sensing circuit which senses the state of resistance of the fuse.

According to example embodiments, a method of operating an electrical fuse device may include providing a fuse, and a driving element connected to the fuse and including a resistance change layer having a resistance that changes according to an applied voltage; and applying a programming current to the fuse by turning on the driving element.

The resistance change layer may have a metal-insulator transition (MIT) characteristic. The driving element may include two electrodes and the resistance change layer that is interposed between the two electrodes. The driving element may further include a gate which applies an electric field to the resistance change layer. In turning on the driving element, an electric field may be applied to the resistance change layer from the gate. The resistance change layer may include an oxide or a sulfide. The oxide may include at least one selected from the group consisting of a vanadium (V) oxide, a niobium (Nb) oxide, and a titanium (Ti) oxide. The sulfide may include a vanadium (V) sulfide.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1 illustrates an electrical fuse device according to example embodiments;

FIG. 2 is a graph showing voltage versus current of a driving element of FIG. 1;

FIG. 3 illustrates an electrical fuse device according to example embodiments; and

FIGS. 4 and 5 are circuit diagrams illustrating an electrical fuse device according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Various example embodiments will now be described more fully with reference to the accompanying drawings in which some example embodiments are shown. Detailed illustrative example embodiments are disclosed herein. However, specific structural and functional details disclosed herein are merely representative for purposes of describing example embodiments. Example embodiments may, however, be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element or layer is referred to as being “formed on” another element or layer, it can be directly or indirectly formed on the other element or layer. That is, for example, intervening elements or layers may be present. In contrast, when an element or layer is referred to as being “directly formed on” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. In the drawings, the thicknesses of layers and regions are exaggerated for clarity. Like reference numerals in the drawings denote like elements.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

FIG. 1 illustrates an electrical fuse device according to example embodiments. Referring to FIG. 1, the electrical fuse device according to example embodiments may include a fuse 100 and a driving element 200 electrically connected to the fuse 100. The fuse 100 may include an anode A1, a cathode C1, and a fuse link L1 that connects the anode A1 and the cathode C1. The anode A1 and the cathode C1 may be connected to a power source V1 and the driving element 200, respectively. The driving element 200 may have a structure in which a resistance change layer D1 is interposed between two electrodes (hereinafter, first and second electrodes) E1 and E2, as illustrated in the partially-expanded cross-sectional view of FIG. 1. The structure of the driving element 200 may be similar to the structure of a conventional capacitor. Thus, the driving element 200 may be similar to a capacitor in the circuit diagram of FIG. 1.

However, the driving element 200 may act not as a capacitor for storing charges but as a switch for applying a programming current to the fuse 100. One of the first and second electrodes E1 and E2, for example, the first electrode E1, may be connected to the fuse 100, and the other one, for example, the second electrode E2, may be grounded. The resistance change layer D1 may have a characteristic in which resistance changes according to voltages applied thereto, more particularly, a metal-insulator transition (MIT) characteristic. For example, the resistance change layer D1 may be an MIT material layer.

In example embodiments, the resistance change layer D1 may have a higher resistance similar to an insulator when a lower voltage than a threshold voltage is applied thereto. However, when a higher voltage than the threshold voltage is applied to the resistance change layer D1, the resistance change layer may have a lower resistance similar to a metal. The resistance change layer D1 having the MIT characteristic may be an oxide layer or a sulfide layer. The oxide layer may include at least one selected among from the group consisting of a vanadium (V) oxide, a niobium (Nb) oxide, and a titanium (Ti) oxide, and the sulfide layer may include a vanadium (V) sulfide.

In a method of operating the electrical fuse device having the above structure according to example embodiments, when a higher voltage than the threshold voltage is applied between the first and second electrodes E1 and E2 due to the power source V1, the resistance of the resistance change layer D1 may be rapidly reduced, and the driving element 200 may be turned on. As the driving element 200 is turned on, a programming current may flow through the fuse 100 connected to the driving element 200, and the fuse 100 may be blown due to the programming current.

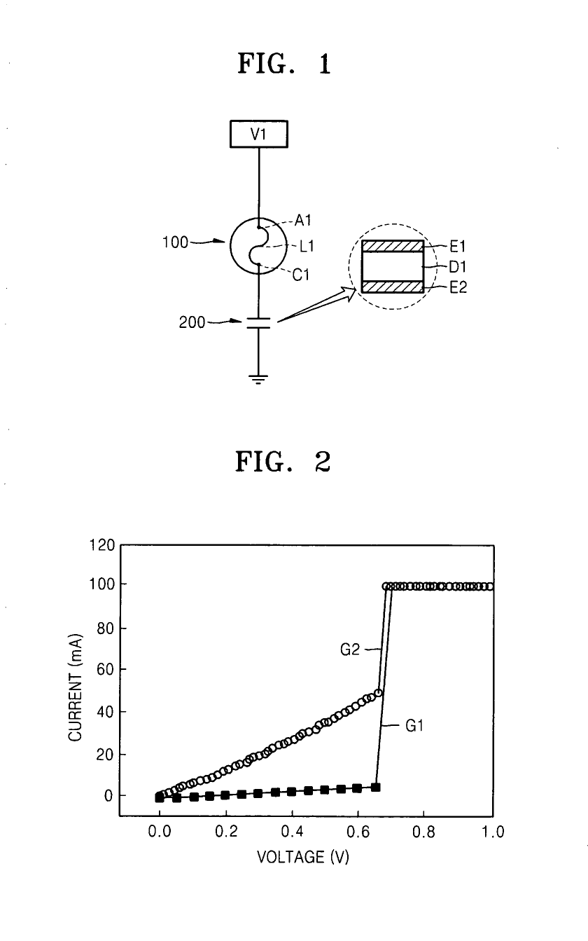

FIG. 2 is a graph showing voltage versus current of the driving element 200 of FIG. 1. In FIG. 2, a first graph G1 illustrates the case where the size of the resistance change layer D1 is 10×10 μm², and a second graph G2 illustrates the case where the size of the resistance change layer D1 is 30×30 μm². In example embodiments, a vanadium (V) oxide layer having the thickness of about 5-about 15 nm may be used as the resistance change layer D1, and a metal layer, e.g., Pt or Al, and a polysilicon layer may be used as the first and second electrodes E1 and E2, respectively.

Referring to FIG. 2, in the first and second graphs G1 and G2, the state of resistance when a voltage of about 0.65 V is applied to the resistance change layer D1 may be rapidly changed. In other words, when the voltage of about 0.65 V is applied to the resistance change layer D1, the state of the resistance change layer D1 may be changed from a higher resistance state to a lower resistance state. An off-current level shown in the first graph G1 may be about 0, and an off-current shown in the second graph G2 may gradually increase as a voltage is increased from about 0 V to about 0.65 V.

As a result, as the size of the resistance change layer D1 is reduced, e.g., as the size of the driving element 200 is reduced, an off characteristic may be improved. On-currents shown in the first and second graphs G1 and G2 are similar, about 100 mA. The intensity of the on-current may be enough to blow the fuse 100 of FIG. 1. In other words, although the driving element 200 is relatively small, a large enough on-current to blow the fuse 100 may be obtained. Thus, according to example embodiments, although the driving element 200 having a smaller size is used, a sufficiently large programming current may be applied to the fuse 100, and as such, a larger programming pre/post resistance ratio may be obtained.

In addition, the first and second graphs G1 and G2 may be close to a vertical line in a position where MIT occurs, e.g., in a position where the driving element 200 is turned on. Therefore, turn-on delay may be close to 0 and a switching characteristic may be improved. Thus, according to example embodiments, the programming speed of the electrical fuse device may be increased and the reliability of a programming operation may be improved.

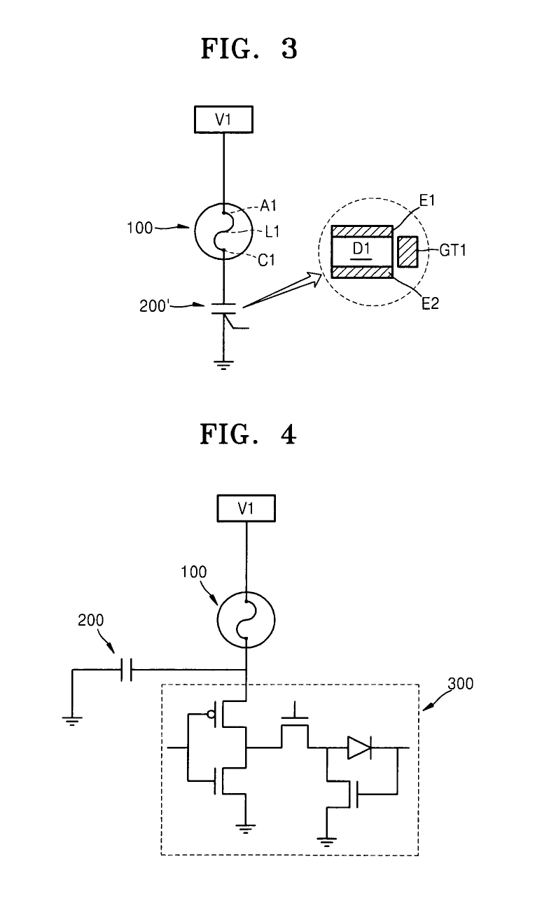

The structure of FIG. 1 may be modified in various shapes. For example, the driving element 200 of FIG. 1 may have a similar structure to the structure of a capacitor. However, according to example embodiments, the driving element 200 may also be modified in a similar structure to that of a thyristor. An example thereof is shown in FIG. 3.

Referring to the partially-expanded cross-sectional view of FIG. 3, a driving element 200′ may further include a gate GT1 for applying an electric field to the resistance change layer D1. A gate insulating layer (not shown) may be interposed between the resistance change layer D1 and the gate GT1. The driving element 200′ may have a similar structure to that of a thyristor. Thus, the driving element 200′ in the circuit diagram of FIG. 3 may be similar to the thyristor.

In order to operate the driving element 200′ of FIG. 3, the driving element 200′ may be turned on by applying a voltage between the first and second electrodes E1 and E2 when a predetermined or given gate voltage is applied to the gate GT1. The turn-on voltage of the driving element 200′ may change according to the intensity of the electric field applied to the resistance change layer D1 from the gate GT1, e.g., according to the intensity of the gate voltage. When the electrical fuse device includes a plurality of fuses 100 and the driving elements 200′ which are connected to the fuses 100, respectively, a turn-on voltage of one driving element selected from among the plurality of driving elements 200′ may be selectively reduced so that the one driving element selected from among the driving elements 200′ may be turned on and the fuse 100 connected to the one driving element 200′ may be selectively blown.

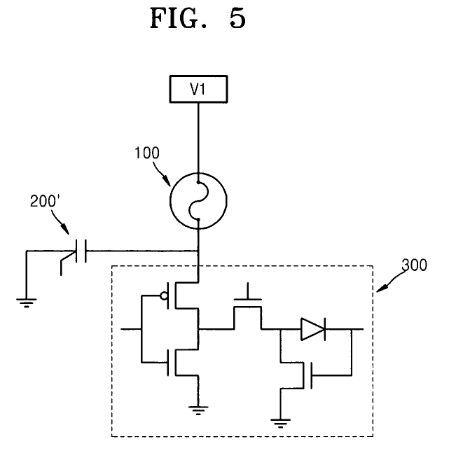

The structure shown in each of FIGS. 1 and 3 may further include a sensing circuit electrically connected to the fuse 100 and sensing the state of resistance of the fuse 100. In example embodiments, the sensing circuit may be a single-ended type of sensing circuit. An example in which a single-ended sensing circuit 300 is added to the structures of FIGS. 1 and 3 is shown in FIGS. 4 and 5.

Referring to FIGS. 4 and 5, the single-ended sensing circuit 300 may be connected to the fuse 100, and driving elements 200 and 200′ may be interposed between the fuse 100 and the single-ended sensing circuit 300. The configuration of the single-ended sensing circuit 300 may be well known to one of ordinary skill in the art, and thus, a detailed description thereof will be omitted. The single-ended sensing circuit 300 may be just an example and may be modified in various shapes. The single-ended sensing circuit 300 may have a relatively simple structure and a relatively small size.

According to example embodiments, an increased programming pre/post resistance ratio may be obtained, as mentioned previously, and thus, the single-ended sensing circuit 300 may be used. When a programming pre/post resistance ratio is relatively small, a resistance resistor and a sensing circuit having a complicated structure, e.g., a double-ended sensing circuit, may be used so as to accurately perform a sensing operation. However, in example embodiments, the single-ended sensing circuit 300 may be used. Thus, an electrical fuse device having a simpler structure and a smaller size may be realized.

A plurality of electrical fuse devices according to example embodiments may be arranged, may have a two-dimensional array structure, and may be used for various purposes, e.g., a semiconductor memory device, a logic device, a microprocessor, a field programmable gate array (FPGA), and other very large scale integration (VLSI) circuits.

While example embodiments have been particularly shown and described with reference to example embodiments thereof, it will be understood by those skilled in the art that various changes in form and details may be made therein without departing from the spirit and scope of the appended claims. Example embodiments should be considered in descriptive sense only and not for purposes of limitation. For example, the structure and elements of the electrical fuse device shown in each of FIGS. 1, 3, 4, and 5 may be variously changed. As a specific example, in FIGS. 1, 3, 4, and 5, the positions of the fuse 100 and the driving elements 200 and 200′ may be interchanged, and a selecting device connected to the driving elements 200 and 200′ may be further provided. In addition, in FIGS. 4 and 5, another sensing circuit, for example, a double-ended sensing circuit, instead of the single-ended sensing circuit 300, may also be used. In example embodiments, a reference resistor may be used together with the double-ended sensing circuit. Therefore, the scope of example embodiments is defined not by the detailed description of example embodiments but by the appended claims, and all differences within the scope will be construed as being included in example embodiments.

What is claimed is:

1. An electrical fuse device comprising:
a fuse; and
a driving element connected to the fuse and including a resistance change layer having a resistance that changes according to an applied voltage.

2. The electrical fuse device of claim 1, wherein the resistance change layer has a metal-insulator transition (MIT) characteristic.

3. The electrical fuse device of claim 1, wherein the driving element includes two electrodes and the resistance change layer is between the two electrodes.

4. The electrical fuse device of claim 3, wherein the driving element further comprises:
a gate configured to apply an electric field to the resistance change layer.

5. The electrical fuse device of claim 2, wherein the resistance change layer includes an oxide or a sulfide.

6. The electrical fuse device of claim 5, wherein the oxide includes at least one selected among from the group consisting of a vanadium (V) oxide, a niobium (Nb) oxide, and a titanium (Ti) oxide.

7. The electrical fuse device of claim 5, wherein the sulfide includes a vanadium (V) sulfide.

8. The electrical fuse device of claim 1, further comprising:
a single-ended sensing circuit configured to sense the state of resistance of the fuse.

9. A method of operating an electrical fuse device comprising:
providing a fuse, and a driving element connected to the fuse and including a resistance change layer having a resistance that changes according to an applied voltage; and
applying a programming current to the fuse by turning on the driving element.

10. The method of claim 9, wherein the resistance change layer has a metal-insulator transition (MIT) characteristic.

11. The method of claim 9, wherein providing the driving element further comprises:
providing two electrodes and the resistance change layer between the two electrodes.

12. The method of claim 11, wherein providing the driving element further comprises:
providing a gate configured to apply an electric field to the resistance change layer.

13. The method of claim 12, wherein turning on the driving element further comprises:
applying an electric field to the resistance change layer from the gate.

14. The method of claim 10, wherein the resistance change layer includes an oxide or a sulfide.

15. The method of claim 14, wherein the oxide includes at least one selected from the group consisting of a vanadium (V) oxide, a niobium (Nb) oxide, and a titanium (Ti) oxide.

16. The method of claim 14, wherein the sulfide includes a vanadium (V) sulfide.
